(19) United States
(12) Patent Application Publication
(10) Pub. No.: US 2009/0157265 A1
(43) Pub. Date: Jun. 18, 2009

(54) MANUAL LEVELING CONTROL SYSTEM AND METHOD FOR CONSTRUCTION EQUIPMENT

(75) Inventors: Jin Seop KIM, Changwon-si (KR); Chang Soo Lee, Changwon-si (KR); In Woo Kim, Changwon-si (KR)

Correspondence Address: LADAS & PARRY LLP, 26 WEST 61ST STREET, NEW YORK, NY, 10023, US

(73) Assignee: VOLVO CONSTRUCTION EQUIPMENT HOLDING SWEDEN AB.

(21) Appl. No.: 12/331,652

(22) Filed: Dec. 10, 2008

(30) Foreign Application Priority Data
Dec. 13, 2007 (KR) 10-2007-0129817

(51) Int. Cl. G06F 19/00

(52) U.S. Cl. 701/50

(57) ABSTRACT

A manual leveling control system and method for construction equipment is provided. The manual leveling control system for construction equipment includes a swing angle sensing unit sensing a swing angle of an upper swing frame and transmitting a signal for the sensed swing angle; a tilting manipulation input unit generating and transmitting a tilting manipulation signal corresponding to coordinate values on a coordinate system, having coordinate axes corresponding to left/right direction and front/rear direction of the upper swing frame, in accordance with a position manipulated by a user; and a control unit determining target actuators to be operated among actuators radially positioned around a tilting unit using the coordinate values of the tilting manipulation signal and the swing angle of the upper swing frame, and calculating operation values for determining whether to extend/contract the target actuators and operation ranges of the target actuators, in order to tilt the upper swing frame against a reference surface in accordance with the tilting manipulation signal.

### CROSS-REFERENCE TO RELATED APPLICATION

This application is based on and claims priority from Korean Patent Application No. 10-2007-0129817, filed on Dec. 13, 2007 in the Korean Intellectual Property Office, the disclosure of which is incorporated herein in its entirety by reference.

### BACKGROUND OF THE INVENTION

1. Field of the Invention

The present invention relates generally to a leveling control system and method for construction equipment, and more particularly to a manual leveling control system and method for construction equipment, which can perform a leveling in accordance with a user's manual manipulation.

2. Description of the Prior Art

In construction equipment, such as an excavator, a logging device, a crane, and the like, which is working on an inclined site, an upper swing frame is inclined to a horizontal surface depending on the ruggedness of ground.

When the construction equipment is in an inclined state, inclination of an upper swing frame against a horizontal surface is changed as the upper swing frame is swiveled, and this causes the work to be done in an unstable state of the equipment. Also, as the center of gravity of the equipment is moved, a danger of overturning of the construction equipment is increased.

In order to solve this problem, a method of moving the center of gravity of the construction equipment near to ground through tilting of an upper swing frame on an inclined site has been used.

As a recent technology related to the above-described method, U.S. Pat. No. 6,609,581 discloses a tilting unit having an upper support being supported and tilted by two hydraulic cylinders.

Also, U.S. Pat. No. 6,158,539 discloses two hydraulic cylinders, upper bearing body support plate coupled to a center tilt shaft, and a lower plate.

On the other hand, Korean Patent Application No. 10-2007-112983, filed by the applicant, discloses a leveling apparatus for excavator and forestry equipment having a tilting unit provided with four actuators.

In manipulating the tilting unit, the displacement value of a joystick is inputted on the basis of the front direction of a lower frame, and if an upper swing frame swivels right and left, a user should input the manipulation displacement of the joystick in consideration of the swing angle of the upper swing frame to cause inconvenience in use.

For example, it is frequent that the construction equipment starts its work after the upper swing frame swivels by 180°. In this case, if an operator manipulates the joystick to the left to add a positive inclination to the left side of the upper swing frame on the basis of the operator, the conventional tilting unit receives the input value on the basis of the front side of the lower frame and operates to add the positive inclination to the right side of the upper swing frame against the operator's intention. If such an error is made by an unskilled operator in a state that the construction equipment is on steep ground, the center of gravity of the equipment is moved in a wrong direction, and this may cause a safety accident, such as overturning of the construction equipment, to occur.

Accordingly, there is a need for development of a tilting system which facilitates user's manipulation of a joystick by making it possible that the tilting manipulation is performed in the front direction of a user, i.e. in the front direction of the upper swing frame.

### SUMMARY OF THE INVENTION

Accordingly, the present invention has been made to solve the above-mentioned problems occurring in the prior art while advantages achieved by the prior art are maintained intact.

One object of the present invention is to provide a manual leveling control system and method for construction equipment, which can control the leveling of an upper swing frame in accordance with a user's intention.

In order to accomplish the above and other objects, there is provided a manual leveling control system for construction equipment having a tilting unit that is coupled between a lower frame having a traveling means and an upper swing frame having a cab and is so operated by actuators as to tilt the upper swing frame, wherein the upper swing frame swivels against the tilting unit, according to embodiments of the present invention, which includes a swing angle sensing unit sensing a swing angle of the upper swing frame and transmitting a signal for the sensed swing angle; a tilting manipulation input unit generating and transmitting a tilting manipulation signal corresponding to coordinate values on a coordinate system, having coordinate axes corresponding to left/right direction and front/rear direction of the upper swing frame, in accordance with a position manipulated by a user; and a control unit determining target actuators to be operated among actuators radially positioned around the center of the tilting unit from the coordinate values of the tilting manipulation signal and the swing angle of the upper swing frame, and calculating operation values for determining whether to extend/contract the target actuators and operation ranges of the target actuators, in order to tilt the upper swing frame against a reference surface in accordance with the tilting manipulation signal.

The control unit may include a manipulation signal analysis module outputting an angle of the coordinates and a coordinate distance or size from an original point to a coordinate point in accordance with the coordinate values, a compensation axis angle calculation module calculating a compensation axis angle from the coordinate angle and the swing angle of the upper swing frame, wherein the compensation axis angle indicates in plane view an angle between a reference axis of the reference surface and a tilting compensation axis on a horizontal surface of the upper swing frame, wherein the tilting compensation axis forms a tilting angle to be compensated between the reference surface and the horizontal surface of the upper swing frame, and an operation value calculation module calculating operation values of the target actuators to be operated from the coordinate distance or size and the compensation axis angle.

The actuators radially positioned around the center of the tilting unit may be coupled to both sides of respective tilt shafts which are substantially orthogonal to each other in ‘x’ shape in plane view so that the tilt shafts seesaw, the coordinate distance or size outputted from the manipulation signal analysis module may correspond to an upward or downward tilting angle of the upper swing frame to be compensated or an ascending or descending length of one side of the tilting unit on the tilting compensation axis in accordance with the upward or downward tilting angle to be compensated, and the operation value calculation module may calculate the operation values for controlling the actuators connected to both sides of the same tilt shaft so as to be extended/contracted and vice versa with the same operation range.

In another aspect of the present invention, there is provided a manual leveling control method for construction equipment having a tilting unit that is coupled between a lower frame having a traveling means and an upper swing frame having a cab and is so operated by actuators as to tilt the upper swing frame, wherein the upper swing frame swivels against the tilting unit, which includes (A) receiving a tilting manipulation signal corresponding to position coordinate values generated in accordance with a manipulation of a tilting manipulation input device, and calculating a coordinate angle and a coordinate distance or size from an original point to a coordinate point on a coordinate system having coordinate axes corresponding to left/right direction and front/rear direction of the upper swing frame; (B) calculating a compensation axis angle from the coordinate angle and the swing angle of the upper swing frame, wherein the compensation axis angle indicates in plane view an angle between a reference axis of the reference surface and a tilting compensation axis on a horizontal surface of the upper swing frame, wherein the tilting compensation axis forms a tilting angle to be compensated between the reference surface and the horizontal surface of the upper swing frame; and (C) calculating an operation value for determining whether to extend/contract an actuator and an operation range of the actuator, which is determined as target actuators to be operated among actuators radially positioned around the center of the tilting unit, from the coordinate distance or size and the compensation axis angle, in order to tilt the upper swing frame against the reference surface in accordance with the tilting manipulation signal.

The step (A) may include if the position coordinate values are expressed as the coordinate angle against any one coordinate axis and the coordinate distance or size from the original point to the coordinate point, outputting the coordinate angle and the coordinate distance or size from the tilting manipulation signal of the position coordinate values; and if the coordinate values are expressed as X, Y coordinate values of a coordinate system having an X axis representing the left/right direction of the upper swing frame and a Y axis representing the front/rear direction of the upper swing frame, calculating the coordinate angle against any one coordinate axis and the coordinate distance or size from the original point to the coordinate point, from the X, Y coordinate values.

The actuators radially positioned around the center of the tilting unit may be A+ actuator and A− actuator coupled to both sides of one of tilt shafts which are substantially orthogonal to each other in ‘x’ shape in plane view so that the tilt shafts seesaw, and B+ actuator and B− actuator coupled to both sides of the other tilt shaft; the coordinate distance or size outputted in the step (A) may correspond to an upward or downward tilting angle of the upper swing frame to be compensated or an ascending or descending length of one side of the tilting unit on the tilting compensation axis in accordance with the upward or downward tilting angle to be compensated; and the step (C) may calculate the operation values for controlling the actuators connected to both sides of the same tilt shaft so as to be extended/contracted and vice versa with the same operation range.

An axis in the front direction of the lower frame that is the basis of the swing angle may coincide with the direction of the reference axis of the reference surface, the coordinate angle may be measured on the basis of a positive Y axis that corresponds to the front direction of the upper swing frame, and an angle having the same sign as the swing angle may refer to the same direction as the swing angle while an angle having an opposite sign to the swing angle may refer to an opposite direction to the swing angle, the reference axis may be a vertical axis along lengthwise direction in plane view, which passes through the center of an ‘X’-shaped cross plane of the tilt shafts, and an upper side thereof may refer to a positive direction, and the compensation axis angle may be calculated as the sum of the coordinate angle and the swing angle.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view schematically illustrating construction equipment to which the present invention is applied;

FIG. 2 is a perspective view schematically illustrating a tilting unit to which the present is applied;

FIG. 3 is a plan view of a tilting unit explaining a mount structure of an actuator to which the present invention is applied;

FIG. 4A is a perspective view schematically illustrating a swing bearing mounting plate of a tilting unit to which the present invention is applied;

FIG. 4B is a sectional view taken along line B-B of FIG. 4A;

FIG. 5 is a partially exploded perspective view of a tilt plate of a tilting unit to which the present invention is applied;

FIG. 6A is a perspective view of a tilting unit to which the present invention is applied;

FIG. 6B is a sectional view taken along line A-A of FIG. 6A;

FIG. 7A is a sectional view illustrating the tilting unit on the basis of a tilt shaft A as illustrated in FIG. 2, and FIG. 7B is a sectional view illustrating the tilting unit on the basis of a tilt shaft B as illustrated in FIG. 2;

FIG. 8 is a view illustrating the use state of a tilting unit to which the present invention is applied;

FIGS. 9A to 9D are views illustrating the use states of construction equipment keeping a leveling against inclined surfaces of the ground in every direction;

FIG. 10 is a plan view schematically illustrating a lower frame and a tilting unit to which the present invention is applied;

FIG. 11 is a view illustrating coordinates of a tilting manipulation input unit according to a preferred embodiment of the present invention;

FIG. 12 is a flowchart illustrating a coordinate value conversion process of a tilting manipulation input unit according to a preferred embodiment of the present invention;

FIG. 13 is a view illustrating operation sectors for calculating operation values according to a preferred embodiment of the present invention;

FIG. 14 is a flowchart illustrating a operation value calculating process according to a preferred embodiment of the present invention; and

FIG. 15 is a block diagram illustrating a manual leveling system for construction equipment according to a preferred embodiment of the present invention.

### DETAILED DESCRIPTION OF THE PREFERRED EMBODIMENTS

Hereinafter, a manual leveling control system and method for construction equipment according to preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

The construction equipment to which the present invention is applied is provided with a tilting unit coupled between a lower frame having a traveling means and an upper swing frame having a cab to operate as an actuator that tilts the upper swing frame. Specifically, the tilting unit is interposed between the upper swing frame having a cab and a boom to which a working device is attached and the lower frame having the traveling means such as wheels or a caterpillar, and performs leveling of the upper swing frame with a reference horizontal surface that is perpendicular to the direction of gravity. In the construction equipment, the upper swing frame swivels against the tiling unit. The tilting unit may swivel against the lower frame, but it is preferable that the tiling unit is fixed to the lower frame.

Hereinafter, the construction of the tilting unit 1 according to an embodiment of the present invention will be described.

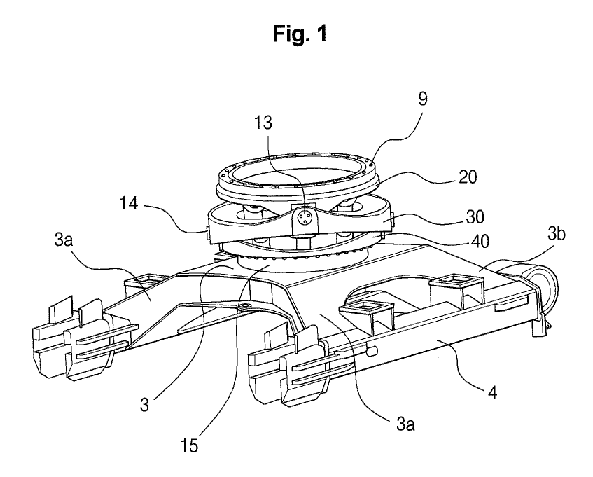

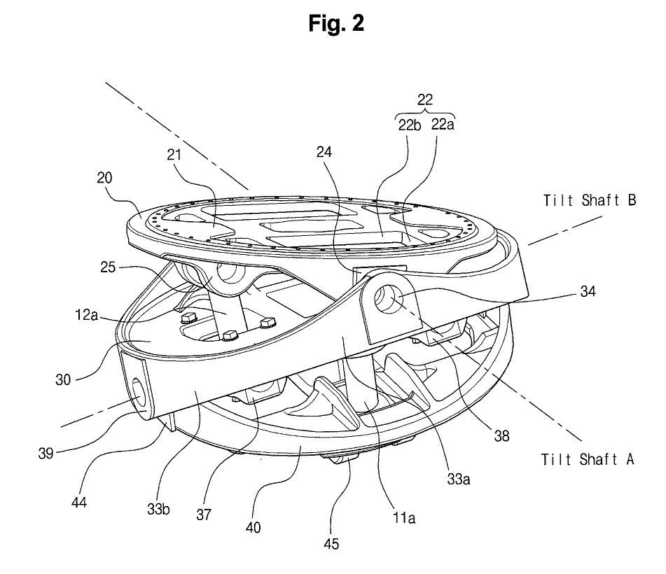

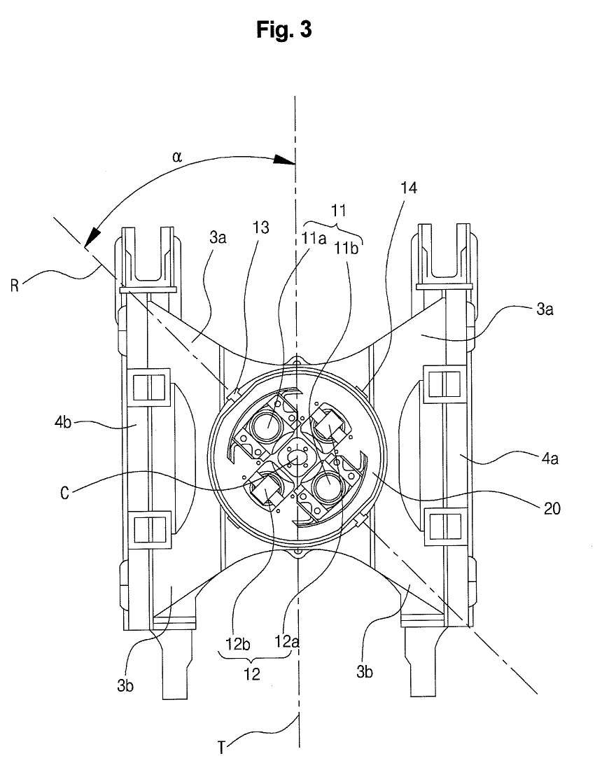

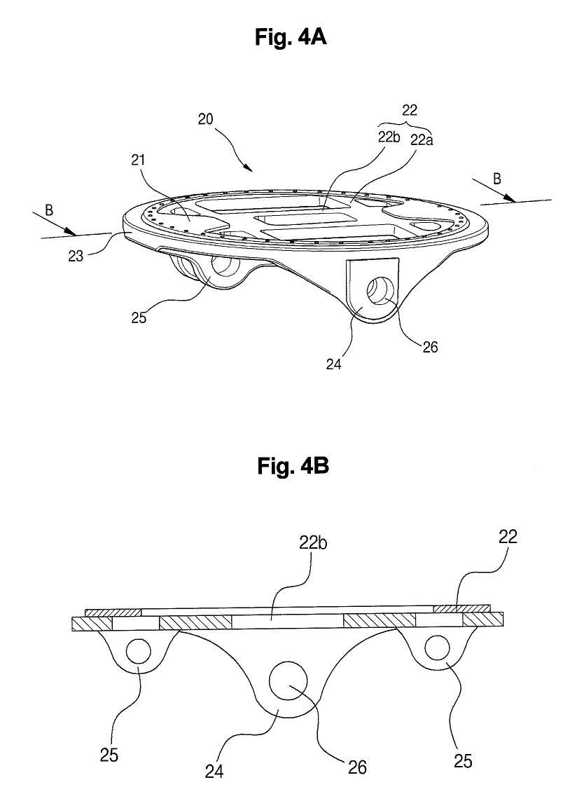

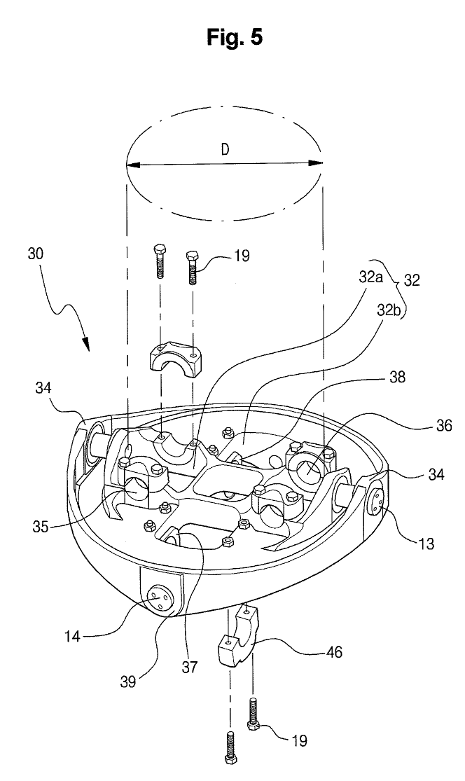

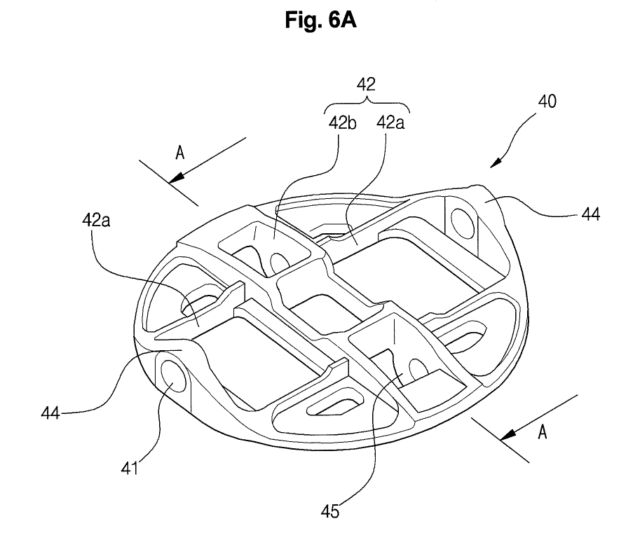

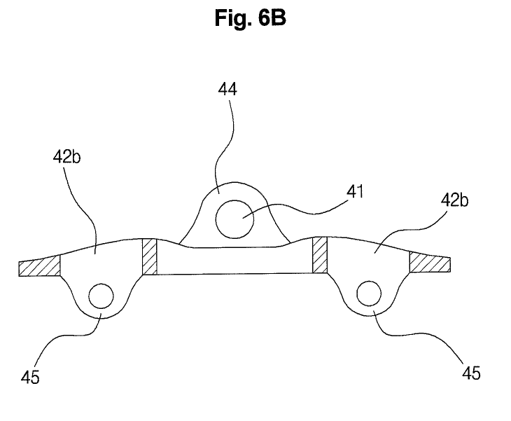

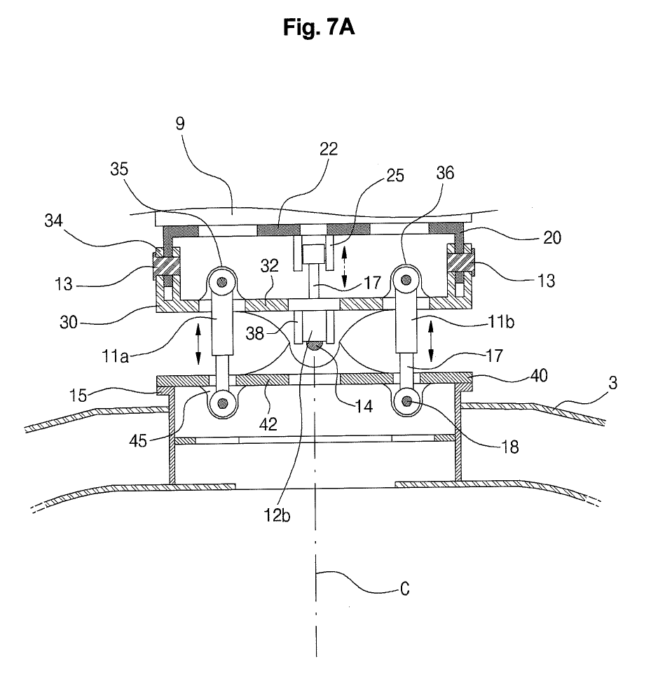

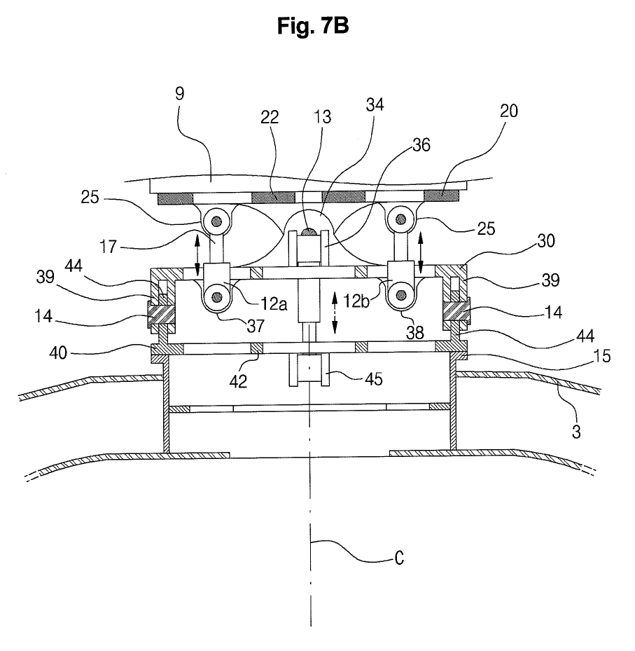

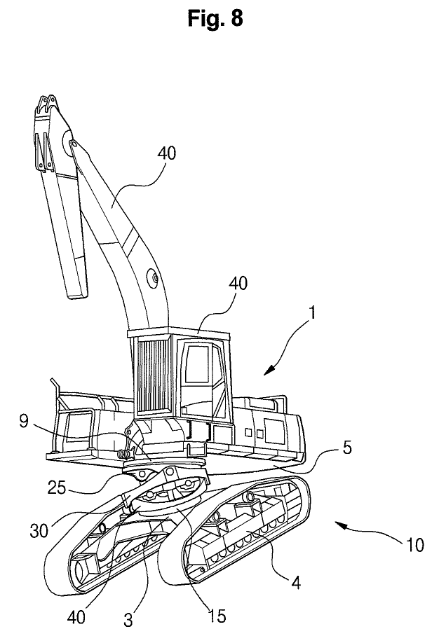

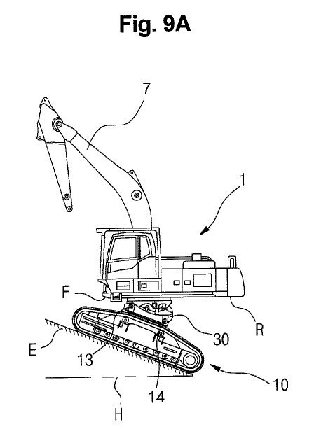

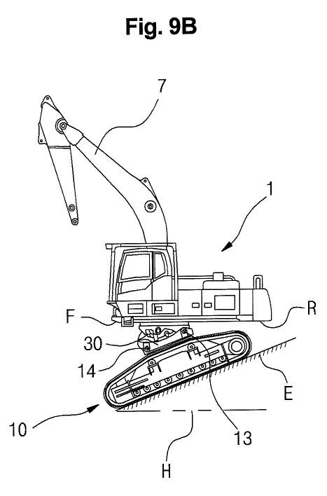

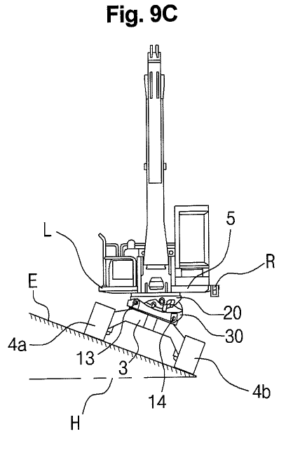

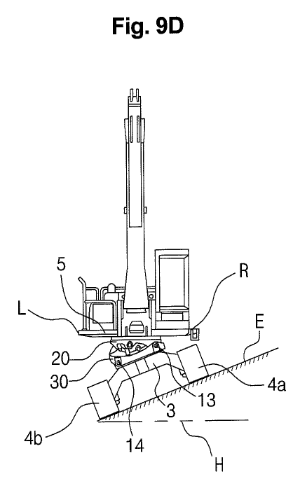

FIG. 1 is a perspective view schematically illustrating construction equipment to which the present invention is applied, FIG. 2 is a perspective view schematically illustrating a tilting unit to which the present is applied, and FIG. 3 is a plan view of a tilting unit explaining a mount structure of an actuator to which the present invention is applied. FIG. 4A is a perspective view schematically illustrating a swing bearing mounting plate of a tilting unit to which the present invention is applied, and FIG. 4B is a sectional view taken along line B-B of FIG. 4A. FIG. 5 is a partially exploded perspective view of a tilt plate of a tilting unit to which the present invention is applied, FIG. 6A is a perspective view of a tilting unit to which the present invention is applied, and FIG. 6B is a sectional view taken along line A-A of FIG. 6A. FIG. 7A is a sectional view illustrating the tilting unit on the basis of a tilt shaft A as illustrated in FIG. 2, and FIG. 7B is a sectional view illustrating the tilting unit on the basis of a tilt shaft B as illustrated in FIG. 2. FIG. 8 is a view illustrating the use state of a tilting unit to which the present invention is applied, and FIGS. 9A to 9D are views illustrating the use states of construction equipment keeping a leveling against inclined surfaces of the ground in every direction.

In the present invention, a tilt shaft means a center shaft connected to one end of an actuator to rock at maximum angle as the actuator extends or contracts. In the case where three actuators operate, three tilt shafts may be provided, and preferably, in the case where four actuators operate, two tilt shafts having both sides, each of which is connected to a pair of actuators, are provided.

A tilting unit is selectively attached to or detached from a lower part of a swing bearing 9 for construction equipment so that it controls a horizontal level of an upper swing frame 1 through controlling of the inclination or tilting of the upper swing frame when the tilting state of the equipment is changed due to a slope or a hill.

In the drawings, the reference numeral “10” denotes a lower frame, “20” denotes a swing bearing mounting plate, “30” denotes a tilt plate, and “40” denotes a support plate.

Referring to the accompanying drawings, the tilting unit is mounted between an upper swing frame 1 and a lower frame 3 formed on the lower driving structure 10 including a swing bearing 9 formed on a lower part of the upper swing frame 1, left and right track chassis 4a and 4b, and a front arm 3a and a rear arm 3b connected to upper parts of the track chassis 4a and 4b, to keep a horizontal level of the upper swing frame 1 against an inclined ground E.

The tilting unit includes a swing bearing mounting plate 20 tiltably mounted on a lower part of the swing bearing 9 and including a pair of pivot support parts 24 projecting in a downward direction of the swing bearing 9 to support a firs tilt shaft A and a pair of second piston holders 25; a support plate 40 fixedly installed on an upper part of the lower frame 3 that tilts in accordance with the inclination of the ground E, and having a pair of pivot support parts 44 projecting to support a second tilt shaft B and a pair of first piston holders 45; a tilt plate 30 mounted between the swing bearing mounting plate 20 and the support plate 40 to be tilted, and including a pair of first pivot holders 34 formed to project upward from one end part 33a of a main body, a pair of second pivot holders 39 formed to project downward from the other end 33b of the main body and to be radially apart from the first pivot holders 34, a first shaft 13 rotatably fixing the first pivot holders 34 and the pivot support parts 24 of the swing bearing mounting plate 20 to form the first tilt shaft A, and a second shaft 14 rotatably fixing the second pivot holders 39 and the pivot support parts 44 of the support plate 40 to form the second tilt shaft B crossing the first tilt shaft A in different directions; and a pair of first actuators 11a and 11b one side of which is fixed to the tilt plate 30 to rock the first tilt shaft A during their expansion and contraction, and a pair of second actuators 12a and 12b fixed to rock one side of the swing bearing mounting plate 20 during their expansion and contraction; wherein the tilt plate 30 includes a vertical center line C crossing a center line T in a length direction of the lower frame 3, and the respective actuators 11a, 11b, 12a, and 12b are installed to be radially apart from the vertical center line C.

Here, the actuators radially positioned around the center of the tilting unit may be coupled to both sides of respective tilt shafts which are substantially orthogonal to each other in ‘x’ shape in plane view so that the tilt shafts seesaw. Preferably, the respective actuators 11a, 11b, 12a, and 12b are fixedly installed on the tilt plate 30 substantially at intervals of 90° radial-apart around a vertical center line C. In the present invention, the term “substantially 90°” includes “accurately 90°” and “approximately 90°” which is almost orthogonal in appearance. Specifically, “substantially 90°” may be concretely in the range of 80°˜100°, preferably in the range of 85°˜95°, more preferably in the range of 88°˜92°, and most preferably 90°.

As illustrated in FIG. 3, it is preferable that at least a pair of the actuators among the first actuators 11a and 11b and the second actuators 12a and 12b are installed opposite to each other on a oblique line R drawn on a left or right side that is at an angle of about 40°˜50° to the center line T in the length direction of the lower frame 3.

In some cases, it can be understood that if the first actuators 11a and 11b are installed opposite to each other on the oblique line R rotated to a left side that is at an angle of about 45° to the center line T of the tilt plate 30, i.e. if one actuator 11a of the pair is installed on the side of the front arm 3a and the other actuator 11b is installed on the side of the rear arm 3b that is at an angle of 180° to the actuator 11a to face the actuator 11a, the other pair of second actuators 12a and 12b may be installed opposite to each other on a oblique line Rotated to a right side that is at an angle of about 45° to the center line T in the same manner.

On the other hand, according to the tilting unit, a pair of first cylinder holders 35 and 36 are provided on the tilt plate 30 to support the first actuators 11a and 11b so that the first actuators 11a and 11b can be extended and contracted downward, and a pair of second cylinder holders 37 and 38 are provided on the tilt plate 30 to support the second actuators 12a and 12b so that the second actuators 12a and 12b can be extended and contracted upward.

When the first actuators 11a and 11b are extended and contracted downward, the first pivot holder 34 and the pivot support part 24 of the swing bearing 9 are moved upward and downward to change the tilt angle of the swing bearing mounting plate 20. When the second actuators 12a and 12b are extended and contracted upward, the second piston holder 25 of the swing bearing 9 is moved upward and downward to change the tilt angle of the swing bearing mounting plate 20.

In explaining the tilting unit, the tilt angle of the swing bearing mounting plate 20 includes an angle and a tilt of the swing bearing mounting plate 20 required to keep a horizontal level of the upper swing frame 1 through offsetting of the inclination to a horizontal surface H.

Also, the tilt plate 30 is provided with a rib frame structure including a plurality of ribs 32a in a horizontal direction corresponding to the direction of the first tilt shaft A and a plurality of ribs 32b in a vertical direction corresponding to the direction of the second tilt shaft B, and the first cylinder holders 35 and 36 and the second cylinder holders 37 and 38 are formed to project from the ribs 32.

Preferably, the ribs 32a in the horizontal direction and the ribs 32b in the vertical direction, which are formed on the tilt plate 30, cross each other at predetermined intervals, the first cylinder holders 35 and 36 fixed to the ribs 32a in the horizontal direction are formed to project upward, and the second cylinder holders 37 and 38 fixed to the ribs 32b in the vertical direction are formed to project downward.

The first cylinder holders 35 and 36 and the second cylinder holders 37 and 38 formed to project upward and downward from the ribs 32 of the tilt plate 30 serve to disperse load, which is applied thereto when the first actuators 11a and 11b and the second actuators 12a and 12b are extended and contracted, through the ribs 32a in the horizontal direction and the rib 32b in the vertical direction of the tilt plate 30.

The second tilt shaft B is below the first tilt shaft A and crosses the first tilt shaft A roughly at an angle of 90°. In the present invention, the term “roughly 90°” has the same meaning as “substantially 90°” as described above.

The actuators 11a, 11b, 12a, and 12b are provided with pistons 17 which expend and contract from a cylinder housing by hydraulic pressure.

Pistons 17 extending and contracting in the first actuators 11a and 11b are fixed to first piston holders 45 of the support plate 40, and pistons 17 extending and contracting in the second actuators 12a and 12b may be fixed to second piston holders 25 of the swing bearing mounting plate 20.

The support plate 40 is fixedly installed on a mounting plate 15 formed in the center of the lower frame 3, and it is proper to fix the support plate through a fixing member (not illustrated) including bolts and a welding means in consideration of its easy attachment and detachment.

With reference to FIG. 2, a coupling relation between the first shaft 13 and the second shaft 14 will be described. The first shaft 13 is provided in consideration of the maximum expansion and contraction range of the actuators and the corresponding interferences. The first shaft 13 is installed in a direction of a slanting line rotated to the left or right side that is at an angle of 40°˜50°, and preferably about 45°, to the center line T in the length direction of the lower frame 3 as in a plan view, and when the first actuators 11a and 11b are extended and contracted upward and downward, the first pivot holders 34 are moved upward and downward on the basis of the second shaft 14 that forms the second tilt shaft B to change the tilt angle of the swing bearing mounting plate 20.

The second shaft 14 is installed in a direction of a slanting line rotated to a left or right side that is at an angle of 40°˜50°, and preferably about 45°, to the center line T in the length direction of the lower frame 3 as in a plan view, and when the second actuators 12a and 12b are extended and contracted upward and downward, the second piston holders 25 are moved upward and downward on the basis of the first shaft 13 that forms the first tilt shaft A to change the tilt angle of the swing bearing mounting plate 20.

In forming the first shaft 13 and the second shaft 14, it is preferable that the directions of the slanting lines coincide with the oblique line R in consideration of the upward/downward movement range of the tilt plate 30 and the swing bearing mounting plate 20 and the center of gravity of the upper swing frame 1 when the leveling is kept.

On the other hand, the support plate 40 is provided with a rib frame structure including a plurality of ribs 42b in a horizontal direction corresponding to the direction of the first tilt shaft A and a plurality of ribs 42a in a vertical direction corresponding to the direction of the second tilt shaft B, and the first piston holders 45 are formed to project downward from the ribs 42b in the horizontal direction to rotatably fix front end parts of the pistons 17 of the first actuators 11a and 11b.

The first piston holders 45 formed to project downward from the ribs 42 serve to disperse load, which is applied through the pistons 17 when the first actuators 11a and 11b are extended and contracted, through the ribs 42b in the horizontal direction and the ribs 42a in the vertical direction.

The swing bearing mounting plate 20 is provided with a rib frame structure including a plurality of ribs 22a in a horizontal direction corresponding to the direction of the first tilt shaft A and a plurality of ribs 22b in a vertical direction corresponding to the direction of the second tilt shaft B, and the second piston holders 25 are formed to project downward from the ribs 22b in the vertical direction to rotatably fix the pistons 17 of the second actuators 12a and 12b.

The second piston holders 25 formed to project downward from the ribs 22 of the swing bearing mounting plate 20 serve to disperse a force or load, which is applied through the pistons 17 when the second actuators 12a and 12b are extended and contracted, through the ribs 22b in the vertical direction and the ribs 22a in the horizontal direction.

As illustrated in FIG. 5, the first cylinder holders 35 and 36 and the second cylinder holders 37 and 38 are provided inside a diameter D that is formed when inner surfaces of the first pivot holders 34 are radially extended. In diverse embodiments of the tilting unit, in order to install the first and second actuators 11a, 11b, 12a, and 12b, it is possible to install a separate bracket or a trunnion on the outside of the first cylinder holders 35 and 36 and the second cylinder holders 37 and 38.

In an embodiment of the tilting unit, as illustrated in FIG. 3, in the case where a pair of first shafts 13 that form the first tilt shaft A are installed to face each other on a oblique line R rotated to the left side that is at an angle of about 40°˜50° to the center line T in the length direction of the lower frame 3 as in a plan view, the first cylinder holders 35 and 36, which are provided with typical rotary pin members, are formed on an upper part of the tilt plate 30 to be apart from each other at an interval of 180° corresponding to the oblique line R, the second cylinder holders 37 and 38 are formed on a lower part of the tilt plate 30 to be apart from each other at an interval of 180° corresponding to the oblique line R, and the first and second actuators 11a, 11b, 12a, and 12b, which maintain the above-described arrangement structure, are mounted to be extended and contracted in the first cylinder holders 35 and 36 and the second cylinder holders 37 and 38.

Also, as illustrated in FIGS. 1 to 3, and 7, in the case of fixedly installing the support plate 40 on the upper part of the lower frame 3 or the upper part of the mounting plate 15, it is preferable that a pair of first pivot holders 34 projecting upward from the tilt plate 30 at a specified height and a pair of second pivot holders 39 are formed at an interval of about 90° as in a plan view, or the first tilt shaft A is arranged in a direction of a slanting line rotated to the left side that is at an angle of about 45° to the center line T in the length direction of the lower frame 3.

In constructing the tilting unit, it can be understood that the center line T in the length direction of the lower frame 3 includes a track center line formed roughly in the center of the length of the typical track chassis 4a and 4b, and it is possible to move the vertical center line C of the tilt frame 30 and the oblique line R on the lower frame 3 in consideration of the movement of the upper swing frame 1 and its center of gravity.

In explaining the tilting unit, the swing bearing mounting plate 20 can be attached to and detached from the swing bearing 9 through a bolting assembly in accordance with various specifications of the conventional swing bearing, and a penetration part for installing therein a turning joint, a hydraulic pipe, and an electric device, and the like, may be further formed roughly in the center of the swing bearing mounting plate 20.

The unexplained reference numeral “14” denotes the second shaft that is shaft-engaged with the second pivot holder 39 of the tilt plate 30 and an engagement hole 41 of the pivot support part 44 of the support plate 40, “18” denotes a piston fixing pin member for fixing the piston holders 25 and 45, “19” denotes a cylinder fixing pin member for fixing the actuators 11a, 11b, 12a, and 12b to the cylinder holders 36, 36, 37, and 38, respectively, “26” denotes a fixing hole for engaging with a bolt for fixing the swing bearing, and “46” denotes a cylinder holder cover for fixing an actuator housing.

Hereinafter, the operation principle and effect of the tilting unit will be described.

The tilting unit is typically operated by a hydraulic pump connected to an engine.

As illustrated in FIGS. 1 to 3, the support plate 40 is mounted on the upper part of the mounting plate 15 formed roughly in the center of the lower frame 3 connected to the left and right track chassis 4a and 4b. On the upper part of the support plate 40, the pivot support parts 44 of the support plate 40 and the second pivot holders 39 of the tilt plate 30 are formed to be tilted at a specified angle by the second shaft 14, and on the upper part of the tilt plate 30, the first pivot holders 34 and the pivot support parts 24 of the swing bearing mounting plate 20 are formed to be tilted at a specified angle by the first shaft 13, so that the upper swing frame 1 and the swing bearing 9 are supported on the upper part of the swing bearing mounting plate 20 through driving forces of the first actuators 11a and 11b and the second actuators 12a and 12b.

When the lower driving structure 10 moves on the ground E that is inclined against the horizontal surface H, the first shaft 13 and the second shaft 14 act as the first tilt shaft A and the second tilt shaft B, which have different heights and cross each other, and by the expansion and contraction of the first actuators 11a and 11b and the second actuators 12a and 12b, the swing bearing mounting plate 20 performs a predetermined up/down seesaw movement along directions of the first tilt shaft A and the second tilt shaft B to change the tilt angle.

For example, when the first actuators 11a and 11b are extended and contracted on the oblique line R rotated at an angle of about 40°˜50° to the oblique line R, a pair of first pivot holders 34 radially apart from each other on the both end parts 33a of the tilt plate 30 and the pivot support parts 24 of the swing bearing mounting plate 20 perform a seesaw movement around the center line (which means the first tilt shaft A) of the second shaft 14 to create up/down displacements, and thus the tilt angle of the swing bearing mounting plate 20 is changed.

Preferably, when the pair of first actuators 11a and 11b and the pair of second actuators 12a and 12b are successively or simultaneously extended and contracted upward and downward in a state that they keep an interval of 90° in a clockwise direction around the vertical center line C of the tilt plate 30, the swing bearing mounting plate 20 makes an angle change required for the horizontal leveling of the upper swing frame 1 in accordance with the inclination of the ground E through the up/down displacements of the first shaft 13 and the second shaft 14 formed on the tilt plate 30.

For example, in the case where the second tilt shaft B is in a horizontal state, but the first tilt shaft A is in an inclined state against the ground E due to the inclination of the ground in the middle of the equipment's going downhill, the first shaft side 13 of the tilt plate 30 that is coupled to the swing bearing mounting plate 20 performs seesaw movements around the second shaft 14 so as to offset the inclination of the first tilt shaft A.

In this case, referring to FIG. 7A, the piston 17 of the first actuator 11a (on the left side in the drawing) fixed to the first cylinder holder 35 of the tilt plate 30 is extended, and simultaneously, the piston 17 of the first actuator 11b (on the right side in the drawing) fixed to the first cylinder holder 36 of the tilt plate 30 is contracted.

Accordingly, the first pivot holder 34 of the tilt plate 30 and the pivot support part 24 of the swing bearing mounting plate 20, which are coupled to each other by the first shaft, perform left/right seesaw movements around the second shaft 14 (which means the second tilt shaft B), and the tilting angle of the swing bearing mounting plate 20 is controlled until the inclination of the ground E is offset, so that the horizontal level of the swing bearing 9 and the upper swing frame 1 is kept to coincide with the horizontal surface E.

Here, the load being applied to the tilt plate 30 and the support plate 40 during the expansion and contraction of the first actuators 11a and 11b is dispersed by the rib frame structure formed on the respective ribs 32 and 42 through the first cylinder holders 35 and 26 and the first piston holders 45 of the support plate 40.

Also, since the first actuators 11a and 11b can be extended and contracted upward/downward at maximum on the left side or the right side that is at an angle of about 40°˜50° to the center line T in the length direction of the lower frame 3, the rear part R of the upper swing frame 1 appears not to collide or interfere with the track chassis 4a and 4b of the lower frame 3.

In other words, even in the case of installing the first actuators 11a and 11b or the second actuators 12a and 12b adjacent to the center line T in the length direction of the left/right lower frame 3, a danger of interference or collision of the lower part of the upper swing frame 1 with the left and right track chassis 4a and 4b can be removed.

On the other hand, in the case where the first tilt shaft A is in a horizontal state, but the second tilt shaft B is inclined against the ground E, both end parts 23 of the swing bearing mounting plate 20 perform seesaw movements around the first shaft 13 so as to offset the inclination of the second tilt shaft B.

That is, as illustrated in FIG. 7B, the second actuator 12a on the left side as in the drawing is extended on the second piston holder 25 adjacent to one end part 23 of the swing bearing mounting plate 20, and simultaneously, the second actuator 12b on the right side as in the drawing is contracted.

Accordingly, even if the tilt plate 30 and the support frame 40 are inclined on the upper part of the lower frame 3, the left side and the right side of the swing bearing mounting plate 20 perform right/left seesaw movements around the first shaft 13 (which means the first tilt shaft A), and the tilting angle of the swing bearing mounting plate 20 is controlled until the inclination of the ground E is offset, so that the horizontal level of the swing bearing 9 and the upper swing frame 1 is kept to coincide with the horizontal surface E.

On the other hand, as illustrated in FIGS. 9A to 9D, in the case where the upper swing frame 1 is tilted to front and rear sides corresponding to the center line T in the length direction of the lower frame 3 or to left and right sides due to the inclination of the ground E, both the first tilt shaft A and the second tilt shaft B are inclined against the ground E, and in this case, it is required for the first shaft 13 and the second shaft 14 to simultaneously or successively perform seesaw movements.

That is, both the first actuators 11a and 11b and the second actuators 12a and 12b are extended and contracted to push or pull the pivot support sides 24 and the second piston holders 25 of the swing bearing mounting plate 20 so that the upper swing frame 1 is kept at the horizontal level as a danger of the collision or interference of the front (F), rear (R), left (L), or right (R) side of the lower part of the upper swing frame 1 is removed.

At this time, for the change of the tilt angle, the rocking movements of the swing bearing mounting plate 20 and the tilt plate 30 are performed as the actuators 11a, 11b, 12a, and 12b fixed to the cylinder holders 35, 36, 37, and 38 of the tilt plate 30, respectively, are alternately or successively extended and contracted, or almost simultaneously driven. Since the upward/downward seesaw movements are performed around the first shaft 13 and the second shaft 14 in the same manner during such a tilt operation, the detailed description thereof will be omitted.

According to an embodiment of the tilting unit, the tilt plate 30 and the support plate 40 are installed on the mounting plate 15 formed roughly in the center of the lower frame 3, the first actuators 11a and 11b are installed opposite to each other on the oblique line R drawn on the right side that is at an angle of 45° to the center line T in the length direction of the lower frame 3, and the leveling range of the equipment in every direction is adjusted over 20° against the horizontal surface H when the second actuators 12a and 12b are opposite to each other on the left side that is at an angle of 45°.

According to the tilting unit, the tilt range of the upper swing frame 1 that is mounted on the upper part of the swing bearing mounting plate 20 does not lean upon the inclined area in the left/right direction of the equipment or the inclined area in the front/rear direction, but is roughly symmetrically applied, so that the capacity and the size of the actuators are relatively reduced in comparison to the conventional structure with the height of the equipment kept lowered.

The expansion and contraction of the first actuators 11a and 11b and the second actuators 12a and 12b as described above may be diversely modified through an algorithm preset to control the flow rate or the size of the cylinders in accordance with the tilt angle of the upper swing frame required during the movement of the equipment on the inclined ground E.

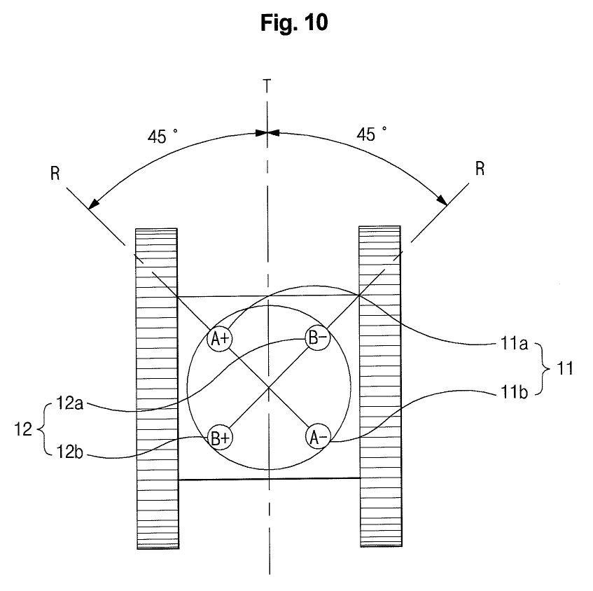

Hereinafter, the position where the tilting unit, to which the present invention is applied, is formed will be described in more detail. Referring to FIGS. 3 and 10, four actuators 11a, 11b, 12a, and 12b are positioned on an upper left side (simply indicated as “A+”), a lower left side (simply indicated as “B+”), an upper right side (simply indicated as “B−”), and a lower right side (simply indicated as “A−”), respectively. The respective actuators are installed to face each other on radial lines R drawn on the left side or right side apart by 45° from the center line T in the length direction of the lower frame.

In operation, one of A+ actuator 11a and A− actuator 11b extends and the other thereof contracts, while one of B+ actuator 12b and B− actuator 12a extends and the other thereof contracts.

Hereinafter, the construction and operation of a manual leveling control system for construction equipment according to a preferred embodiment of the present invention will be described in detail.

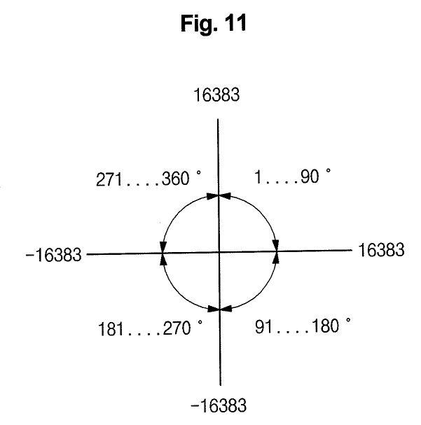

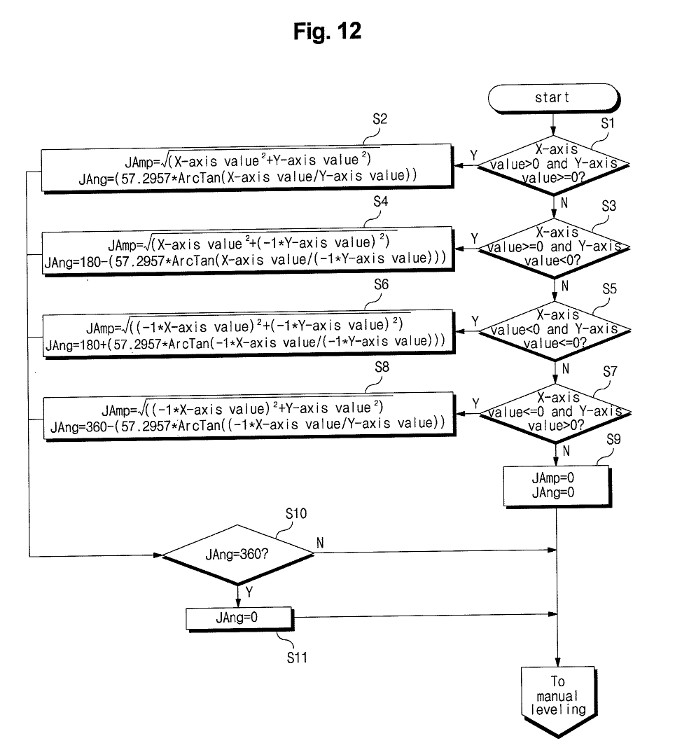

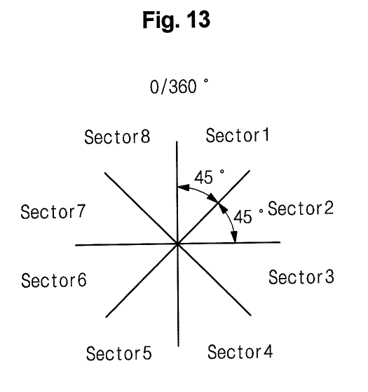

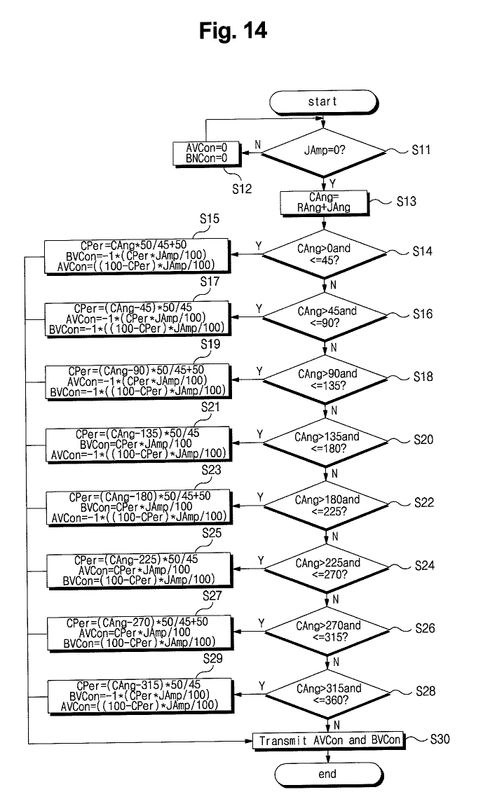

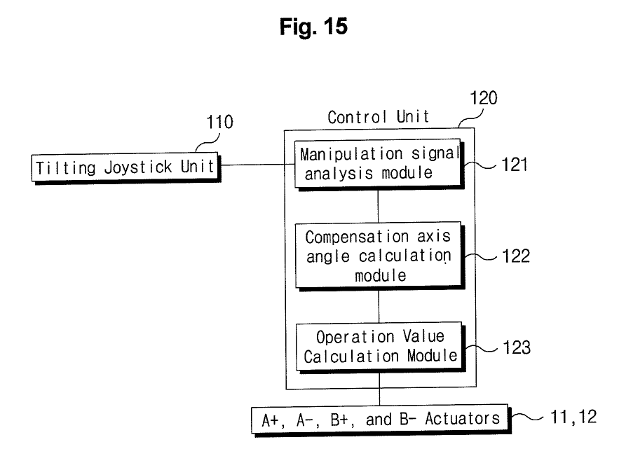

FIG. 10 is a plan view schematically illustrating a lower frame and a tilting unit to which the present invention is applied, and FIG. 11 is a view illustrating coordinates of a tilting manipulation input unit according to a preferred embodiment of the present invention. FIG. 12 is a flowchart illustrating a coordinate value conversion process of a tilting manipulation input unit according to a preferred embodiment of the present invention, FIG. 13 is a view illustrating operation sectors for calculating operation values according to a preferred embodiment of the present invention, and FIG. 14 is a flowchart illustrating a operation value calculating process according to a preferred embodiment of the present invention. FIG. 15 is a block diagram illustrating a manual leveling system for construction equipment according to a preferred embodiment of the present invention.

The manual leveling control system 100 for construction equipment according to a preferred embodiment of the present invention includes a swing angle sensing unit (not illustrated) sensing a swing angle of the upper swing frame and transmitting a signal for the sensed swing angle; a tilting manipulation input unit (not illustrated) generating and transmitting a tilting manipulation signal corresponding to coordinate values on a coordinate system, having coordinate axes corresponding to left/right direction and front/rear direction of the upper swing frame, in accordance with a position manipulated by a user; and a control unit 120 determining target actuators to be operated among actuators radially positioned around the center of the tilting unit from the coordinate values of the tilting manipulation signal and the swing angle of the upper swing frame, and calculating operation values for determining whether to extend/contract the target actuators and operation ranges of the target actuators, in order to tilt the upper swing frame against a reference surface in accordance with the tilting manipulation signal.

The tilting manipulation input unit includes a tilting manipulation input device 110 such as a tilting joystick as illustrated in FIG. 5. The tilting manipulation input device 110 may be in the form of a trackball, and preferably in the form of a tilting joystick.

The tilting manipulation input device 110 of the tilting manipulation input unit is vertically positioned in plane view if a user does not manipulate the device. The user tilts the tilting manipulation input device to a desired direction, and a manipulation command is generated in accordance with the direction and degree of tilting. At this time, in consideration of the coordinates composed of X axis corresponding to the right/left direction and Y axis corresponding to the front/rear direction of the upper swing frame, the displaced position of the tilting manipulation input unit is expressed as coordinate values. In the embodiment of the present invention, the coordinate values of the tilting manipulation input unit are expressed as an X-axis value and a Y-axis value, or an angle of the corresponding coordinates against the X axis or Y axis and a size value from the original point.

Referring to the coordinates as illustrated in FIG. 11, the manipulation command means coordinate values inputted as the tilting manipulation input device 110 is tilted, and the maximum range value of the respective axis, i.e. the maximum input size value of the tilting manipulation input device 110, may be determined, for example, as “16383” as illustrated in FIG. 11 for user's convenience. This numerical value may be defined as a numerical value suitable to calculate an electric signal value for operating the actuators at maximum, and the scope of the present invention is not reduced or limited by the above-described value “16383”. The maximum ranges of the respective axes may be changed in accordance with the concrete application of the present invention.

On the other hand, the control unit 120 includes a manipulation signal analysis module 121 calculating an angle of the coordinates and a coordinate distance or size from the coordinate values of the tilting manipulation signal of the tilting manipulation input unit, a compensation axis angle calculation module 122 calculating a compensation axis angle that is the basis of selecting the actuators from the coordinate angle and the swing angle of the upper swing frame, and an operation value calculation module 123 calculating operation values of the respective actuator for determining whether the actuator extends or contracts and the operation range from the compensation axis angle and the coordinate distance or size.

The manipulation signal analysis module 121 outputs the coordinate angle and the coordinate distance or size from the original point to the coordinate point, and the coordinate distance or size outputted from the manipulation signal analysis module 121 corresponds to an upward or downward tilting angle of the upper swing frame to be compensated or an ascending or descending length of one side of the tilting unit on a tilting compensation axis in accordance with the upward or downward tilting angle to be compensated.

In an embodiment of the present invention, the manipulation signal analysis module 121 receives the coordinate values transmitted from the tilting manipulation input unit, and calculates the angle of the coordinates rotated clockwise about the axis based on the front part of the upper swing frame, and the coordinate distance or size JAmp that is the distance (or size) from the original point to the coordinate point.

In an embodiment of the present invention, if the coordinate angle is determined as 0°˜360° based on the clockwise rotation and the coordinate values are in the range of 0<(X−axis value)(x) and 0≦(Y−axis value)(y), the coordinate size JAmp is calculated by JAmp=\sqrt{x²+y²}, and the coordinate angle JAng is calculated by

$$JAng = [ 57.2957 \times Arc Tan ( \frac{x}{y} ) ]$$

through the manipulation signal analysis module. Here, the constant “57.2957” is to calculate the radian value by the arctangent in terms of degrees, and accurately corresponds to 180/π. The proper change of such constant values is apparent to those skilled in the art.
If the coordinate values are in the range of 0≦(X−axis value)(x) and 0>(Y−axis value)(y), the coordinate size JAmp is calculated by JAmp=\sqrt{x²+(−y)²}, and the coordinate angle JAng is calculated by

$$JAng = 180 - [ 57.2957 \times Arc Tan ( \frac{x}{- y} ) ] .$$

If the coordinate values are in the range of 0>(X−axis value)(x) and 0≧(Y−axis value)(y), the coordinate size JAmp is calculated by JAmp=\sqrt{(−x)²+(−y)²}, and the coordinate angle JAng is calculated by

$$JAng = 180 + [ 57.2957 \times Arc Tan ( \frac{- x}{- y} ) ] .$$

If the coordinate values are in the range of 0≧(X−axis value)(x) and 0<(Y−axis value)(y), the coordinate size JAmp is calculated by JAmp=\sqrt{(−x)²+y²}, and the coordinate angle JAng is calculated by

$$JAng = 360 - [ 57.2957 \times Arc Tan ( \frac{- x}{y} ) ] .$$

Meanwhile, if the coordinate values are in the range of (X−axis value)=0 and (Y−axis value)=0, the coordinate size JAmp is calculated as ‘0’ and the coordinate angle JAng is calculated as ‘0’.

If the coordinate angle is calculated as ‘360’, the coordinate angle is calculated as ‘0’ since 360° and 0° have the same meaning.

In other embodiments of the present invention, the coordinate angle may be determined in a different range, e.g. in the range of −180°˜180°.

The compensation axis angle calculation module 122 calculates a compensation axis an gle that is the basis of selection of the actuators to be operated from the coordinate angle and the swing angle of the upper swing frame, and the compensation axis angle indicates a plane angle between the tilting compensation axis on a horizontal surface of the upper swing frame and a reference axis of the reference surface, wherein the tilting compensation axis forms a tilting angle to be compensated between the reference surface and the horizontal surface of the upper swing frame. Here, the reference surface means a surface that is the basis of leveling of the inclined upper swing frame, and preferably is a surface perpendicular to the direction of gravity. Also, the reference axis of the reference surface becomes the basis for making a tilting angle for the tilting compensation of the upper swing frame. Preferably, the reference axis coincides with the front direction axis of the lower frame in plane view.

Since the compensation axis angle includes the current swing angle of the upper swing frame, the basis of tilting is changed from the lower frame to the upper swing frame. In an embodiment of the present invention, the compensation axis angle is calculated as “coordinate angle+swing angle of upper swing frame”.

In an embodiment of the present invention, the front direction axis of the lower frame that is the basis of the swing angle coincides with the direction of the reference axis of the reference surface, the coordinate angle is measured on the basis of the positive Y axis that is the front direction of the upper swing frame, and an angle having the same sign as the swing angle refers to the same direction as the swing angle while an angle having an opposite sign to the swing angle refers to an opposite direction to the swing angle. Also, the reference axis is a vertical axis along lengthwise direction in plane view, which passes through the center of an ‘X’-shaped cross plane of the tilt shafts, an upper side thereof refers to a positive direction, and the compensation axis angle is calculated as the sum of the coordinate angle and the swing angle.

The operation value calculation module 123 determines whether to extend or contract the respective actuators, and calculates operation values for determining the operation range of the respective actuators in consideration of the compensation axis angle and the coordinate distance or size JAmp. In an embodiment of the present invention, the operation value calculation module 123 calculates operation values for controlling the actuators connected to both sides of the same tilt shaft so as to be extended/contracted and vice versa with the same operation range.

In an embodiment of the present invention, the operation values can be calculated by dividing the operation region into sectors in accordance with the compensation axis angle on the basis of the tilt shaft on the ‘x’-shaped plane crossing the tilt shaft. In this case, the positive sign of the operation value makes the actuator operate in the same direction as the tilting direction to be compensated in the coordinate direction according to the tilting manipulation signal, while the negative sign of the operation value makes the actuator operate in the opposite direction. That is, a downward tilting signal makes the actuator positioned in tilting manipulation direction contract, while the upward tilting signal makes the actuator positioned in tilting manipulation direction extend.

Here, by substantially describing a circular arc having a radius r through connection of points where the actuators joint the tilt shafts, the maximum ascending or descending length or height can be calculated on the above-described circular arc of the tilting unit to be tilted from the coordinate distance or size. If it is assumed that the maximum ascending or descending length or height on the circular arc of the tilting unit is denoted by h, operation values as follows can be roughly obtained using the linear ratio of the length of the circular arc to the ascending or descending height. Here, α is the size value of the compensation axis angle. In the case of manipulating the tilting manipulation input device to be tilt-compensated so that the tilting unit is tilted in a direction of the manipulation coordinates, i.e. downward, the positive sign of the operation value makes the actuators contract, while the negative sign of the operation value makes the actuator ascend. Here, since operation values of A+ and B+ actuators have the same absolute values as those of A− and B− actuators, but have a sign different from that of A− and B− actuators, A+ and B+ actuators extend/contract in a manner opposite to A− and B− actuators. In the following embodiment of the present invention, the length of the circular arc in selecting the compensation axis angle range and calculating the operation values may be differently set in accordance with the accurate crossing angle of the tilt shafts, and such changes are apparent to those of ordinary skill in the art.

i) If the compensation axis angle is more than −45° and less than 45°, i.e. if the size of the compensation axis angle α is in the range of −45≦α<45, the operation value A_{ν}⁺ of A+ actuator is obtained as

$${A}_{v}^{+} = \frac{45 - α}{90} \times h$$

from

$$\frac{π}{2} r \text{:} h = ( \frac{π}{4} - \frac{π}{180} \times α ) r \text{:} {A}_{v}^{+} ,$$

and the operation value B_{ν}⁻ of B− actuator is obtained as

$${B}_{v}^{-} = \frac{45 + α}{90} \times h$$

from

$$\frac{π}{2} r \text{:} h = ( \frac{π}{4} + \frac{π}{180} \times α ) r \text{:} {B}_{v}^{-} .$$

ii) If the compensation axis angle is more than 45° and less than 135°, i.e. if the compensation axis angle α is in the range of 45≦α<135, the operation value A_{ν}⁺ of A+ actuator is obtained as

$${A}_{v}^{+} = - \frac{α - 45}{90} \times h$$

from

$$\frac{π}{2} r \text{:} h = - ( \frac{π}{180} \times α - \frac{π}{4} ) r \text{:} {A}_{v}^{+} ,$$

and the operation value B_{ν}⁻ of B− actuator is obtained as

$${B}_{v}^{-} = \frac{135 - α}{90} \times h$$

from

$$\frac{π}{2} r \text{:} h = [ π - ( \frac{π}{4} + \frac{π}{180} \times α ) ] r \text{:} {B}_{v}^{-} .$$

iii) If the compensation axis angle is in the range of 135≦α<225 in a state that the compensation axis angle in the range of 135≦α<180 or in the range of −180≦α<−135 is the same as the compensation axis angle in the range of 135≦α<225, the operation value A_{ν}⁺ of A+ actuator is obtained as

$${A}_{v}^{+} = - \frac{225 - α}{90} \times h from \frac{π}{2} r \text{:} h = - ( \frac{5 π}{4} - \frac{π}{180} \times α ) r \text{:} {A}_{v}^{+} ,$$

and the operation value B_{ν}⁻ of B− actuator is obtained

$${B}_{v}^{-} = - \frac{α - 135}{90} \times h$$

from

$$\frac{π}{2} r \text{:} h = - ( \frac{π}{180} \times α - \frac{3 π}{4} ) r \text{:} {B}_{v}^{-} .$$

iv) If the compensation axis angle is more than −135° and less than −45°, i.e. if the compensation axis angle α is in the range of −135≦α<−45, the operation value A_{ν}⁺ of A+ actuator is obtained as

$${A}_{v}^{+} = \frac{135 - \vert α \vert}{90} \times h = \frac{135 + α}{90} \times h$$

from

$$\frac{π}{2} r \text{:} h = ( \frac{3 π}{4} - \frac{π}{180} \times \vert α \vert ) r \text{:} {A}_{v}^{+} ,$$

and the operation value B_{ν}⁻ of B− actuator is obtained as

$${B}_{v}^{-} = - \frac{\vert α \vert - 45}{90} \times h = \frac{α + 45}{90} \times h$$

from

$$\frac{π}{2} r \text{:} h = - ( \frac{π}{180} \times \vert α \vert - \frac{π}{4} ) r \text{:} {B}_{v}^{-} .$$

Also, in another embodiment of the present invention, in accordance with the arrangement characteristics of the first and second actuators of the tilting unit to which the present invention is applied, as illustrated in FIG. 13, operation sectors sector1 to sector8 are dividedly arranged at intervals of 45° on the basis of the front direction of the upper swing frame, and in the operation sectors, operation values related to the operation direction of the respective actuators are calculated.

More specifically, operation angles CPer in consideration of the arrangement positions and operable ranges of the respective actuators are defined in accordance with the size of the compensation axis angle, and the operation values for determining whether to extend/contract the respective actuators and the operation ranges of the actuators are calculated as the following control values by considering the operation angles CPer and the coordinate distance or size JAmp as variables.

In accordance with the operation sectors as illustrated in FIG. 13, the operation angles CPer, control values AVCon of A+ and A− actuators, and control values BVCon of B+ and B− actuators are calculated as follows. In obtaining the operation angles, the multiplication of the compensation axis angle by 50/45 is to calculate the angle value in the range of 45° in terms of percentage, and if needed, ‘50’ is added for each operation sector to calculate the angle value in terms of percentage. As the operation angle is calculated in terms of percentage, the coordinate distance or size JAmp is divided by ‘100’ in order to determine the operation value from the corrected value including the operation angle and the coordinate distance or size JAmp in consideration of the operation sectors. It is apparent that the selection of such numerical values can be diversely changed.

Operation Sector 1: In the range of 0<Compensation Axis Angle≦45,

the operation angle CPer is calculated by

$$CPer = CAng \times \frac{50}{45} + 50 ,$$

the control value AVCon of A+ actuator by AVCon=[(100−CPer)×JAmp/100], and calculating the control value BVCon of B+ actuator by BVCon=−1×(CPer×JAmp/100).

Operation Sector 2: In the range of 45<Compensation Axis Angle≦90,

the operation angle CPer is calculated by

$$CPer = ( CAng - 45 ) \times \frac{50}{45} ,$$

the control value AVCon of A+ actuator by AVCon=−1×(CPer×JAmp/100), and calculating the control value BVCon of B+ actuator by BVCon=−1×[(100−CPer)×JAmp/100].

Operation Sector 3: In the range of 90<Compensation Axis Angle≦135,

the operation angle CPer is calculated by

$$CPer = ( CAng - 90 ) \times \frac{50}{45} + 50 ,$$

the control value AVCon of A+ actuator by AVCon=−1×(CPer×JAmp/100), and calculating the control value BVCon of B+ actuator by BVCon=−1×[(100−CPer)×JAmp/100].

Operation Sector 4: In the range of 135<Compensation Axis Angle≦180,

the operation angle CPer is calculated by

$$CPer = ( CAng - 135 ) \times \frac{50}{45} ,$$

the control value AVCon of A+ actuator by AVCon=−1×[(100−CPer)×JAmp/100], and calculating the control value BVCon of B+ actuator by BVCon=CPer×JAmp/100.

Operation Sector 5: In the range of 180<Compensation Axis Angle≦225,

the operation angle CPer is calculated by

$$CPer = ( CAng - 180 ) \times \frac{50}{45} + 50 ,$$

the control value AVCon of A+ actuator by AVCon=−1×[(100−CPer)×JAmp/100], and calculating the control value BVCon of B+ actuator by BVCon=CPer×JAmp/100.

Operation Sector 6: In the range of 225<Compensation Axis Angle≦270,

the operation angle CPer is calculated by

$$CPer = ( CAng - 225 ) \times \frac{50}{45} ,$$

the control value AVCon of A+ actuator by AVCon=CPer×JAmp/100, and calculating the control value BVCon of B+ actuator is calculated by BVCon=(100−CPer)×JAmp/100.

Operation Sector 7: In the range of 270<Compensation Axis Angle≦315,

the operation angle CPer is calculated by

$$CPer = ( CAng - 270 ) \times \frac{50}{45} + 50 ,$$

the control value AVCon of A+ actuator by AVCon=CPer×JAmp/100, and calculating the control value BVCon of B+ actuator by BVCon=(100−CPer)×JAmp/100.

Operation Sector 8: In the range of 315<Compensation Axis Angle≦359,

the operation angle CPer is calculated by

$$CPer = ( CAng - 315 ) \times \frac{50}{45} ,$$

the control value AVCon of A+ actuator by AVCon=[(100−CPer)×JAmp/100], and calculating the control value BVCon of B+ actuator by BVCon=−1×(CPer×JAmp/100).

In addition, in the range of Compensation Axis Angle=0,

the operation angle CPer is calculated by CPer=50, the control value AVCon of A+ actuator by AVCon=[(100−CPer)×JAmp/100], and calculating the control value BVCon of B+ actuator by BVCon=−1×(CPer×JAmp/100).

The control value AVCon of A+ and A− actuators and the control value BVCon of B+ and B− actuators as calculated above have values of ‘0’, a positive number, or a negative number. The control values function as the operation values for operating the actuators.

In this case, if the tilting manipulation signal for the tilting compensation means an downward tilting control, the A+ or B+ actuators contract and the A− or B− actuators extend in the case where the control value AVCon or BVCon is a positive number, while the A+ or B+ actuators extend and the A− or B− actuators contract in the case where the control value AVCon or BVCon is a negative number.

That is, A+ actuator and A− actuator are positioned opposite to each other, and if any one of A+ and A− actuators extends, the other thereof contracts. In other words, their operation lengths are the same, but their operations (including expansion and contraction) are opposite to each other. Such construction is also applied to the B+ and B− actuators in the same manner. Accordingly, if the control values AVCon and BVCon are determined as the operation values, the expansion/contraction of the respective actuators are determined in accordance with the sign of the control values or the operation values, and the operation range of the respective actuators is determined in accordance with the size of the operation values.

Hereinafter, a manual leveling control method for construction equipment according to a preferred embodiment of the present invention will be described in detail.

The manual leveling control method for construction equipment having a tilting unit that is coupled between a lower frame having a traveling means and an upper swing frame having a cab and is so operated by actuators as to tilt the upper swing frame, wherein the upper swing frame swivels against the tilting unit, according to a preferred embodiment of the present invention includes (A) receiving a tilting manipulation signal corresponding to position coordinate values generated in accordance with a manipulation of a tilting manipulation input device, and calculating a coordinate angle and a coordinate distance or size from an original point to a coordinate point on a coordinate system having coordinate axes corresponding to left/right direction and front/rear direction of the upper swing frame; (B) calculating a compensation axis angle from the coordinate angle and the swing angle of the upper swing frame, wherein the compensation axis angle indicates in plane view an angle between a reference axis of the reference surface and a tilting compensation axis on a horizontal surface of the upper swing frame, wherein the tilting compensation axis forms a tilting angle to be compensated between the reference surface and the horizontal surface of the upper swing frame; and (C) calculating an operation value for determining whether to extend/contract an actuator and an operation range of the actuator, which is determined as target actuators to be operated among actuators radially positioned around the center of the tilting unit, from the coordinate distance or size and the compensation axis angle, in order to tilt the upper swing frame against the reference surface in accordance with the tilting manipulation signal.

Preferably, in the manual leveling control method for construction equipment, if the position coordinate values are expressed as the coordinate angle against any one coordinate axis and the coordinate distance or size from the original point to the coordinate point, the step (A) outputs the coordinate angle and the coordinate distance or size from the tilting manipulation signal of the position coordinate values.

In an embodiment of the present invention, if the coordinate values are expressed as X, Y coordinate values of a coordinate system having an X axis representing the left/right direction of the upper swing frame and a Y axis representing the front/rear direction of the upper swing frame, the step (A) calculates the coordinate angle against any one coordinate axis and the coordinate distance or size from the original point to the coordinate point, from the X, Y coordinate values. In this case, the step (A) includes receiving an input of the coordinate values (i.e. X-axis value and Y-axis value) in the coordinates composed of the X axis representing the left/right direction of the upper swing frame and the Y axis representing the front/rear direction of the upper swing frame, and calculating the position of the tilting manipulation input device as the coordinate angles in accordance with the coordinate values (i.e. the X-axis value and the Y-axis value) on the basis of the coordinate distance or size that is the length from the original point of the coordinates and the positive Y axis (steps s1 to s11). Since the details of calculation of the position of the tilting manipulation input device as the coordinate angles in accordance with the coordinate values (i.e. the X-axis value and the Y-axis value) on the basis of the coordinate distance or size that is the length from the original point of the coordinates and the positive Y axis are the same as described above, a duplicate description thereof will be omitted.

Preferably, the coordinate distance of size outputted in step (A) corresponds to the upward or downward tilting angle of the upper swing frame to be compensated or the ascending or descending length of one side of the tilting unit on the tilting compensation axis in accordance with the upward or downward tilting angle to be compensated.

The step (B), if the coordinate distance or size JAmp is ‘0’, returns to the step (A), and sets the operation values AVCon and BVCon of the actuators to ‘0’ to make the actuators stop if no user manipulation command is inputted, so that a state of waiting for the manipulation command in accordance with the user's manipulation of the tilting manipulation input device is maintained (steps s11 to s12).

If the manipulation command is inputted to the tilting manipulation input device and thus the coordinate distance or size JAmp is not ‘0’, the step (B) calculates the compensation axis angle from the coordinate angle and the swing angle of the upper swing frame against the lower frame. Details of this operation are as described above.

In an embodiment of the present invention, the step (B) calculates the compensation axis angle as “compensation axis angle=coordinate angle+swing angle of upper swing frame” (step s13).

On the other hand, the step (C) divides the operation region into sectors in accordance with the compensation axis angle, and calculates i.e. the operation value A_{ν}⁺ of A+ actuator, the operation value B_{ν}⁻ of B− actuator. Since details of this operation are as described above, the duplicate description thereof will be omitted.

Furthermore, in another embodiment of the present invention, the step (C) divides the operation region into sectors in accordance with the compensation axis angle, and calculates the operation angle CPer, the control value AVCon of A+ and A− actuators, the control value BVCon of B+ and B− actuators for the respective operation sectors (steps s14 to s29). Since details of this operation are as described above, the duplicate description thereof will be omitted.

For example, if the tilting manipulation signal for the tilting compensation means the downward tilting control, and the control value AVCon of A+ actuator and the control value BVCon of B+ actuators are positive numbers, the step (C) sends the operation command to contract A+ and B+ actuators as much as the corresponding operation value and to extend the A− and B− actuators, while if the control values are negative numbers, the step (C) sends the operation command to extend A+ and B+ actuators as much as the corresponding operation value and to contract the A− and B− actuators (step s30). If the downward tilting is compensated in the tilting manipulation coordinate direction in accordance with the tilting manipulation signal, the positive value corresponds to the contraction of the actuators and the negative value corresponds to the expansion of the actuators.

As described above, according to the manual leveling control system and method for construction equipment according to embodiments of the present invention, since the manual tilting is performed by user's manipulation of the tilting manipulation input unit in accordance with the user's recognition based on the upper swing frame, confusion in operation of the construction equipment is prevented to increase the safety, and the tilting manipulation becomes convenient.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A manual leveling control system for construction equipment having a tilting unit that is coupled between a lower frame having a traveling means and an upper swing frame having a cab and is so operated by actuators as to tilt the upper swing frame, wherein the upper swing frame swivels against the tilting unit, the manual leveling control system comprising:
a swing angle sensing unit sensing a swing angle of the upper swing frame and transmitting a signal for the sensed swing angle;
a tilting manipulation input unit generating and transmitting a tilting manipulation signal corresponding to coordinate values on a coordinate system, having coordinate axes corresponding to left/right direction and front/rear direction of the upper swing frame, in accordance with a position manipulated by a user; and
a control unit determining target actuators to be operated among actuators radially positioned around the center of the tilting unit from the coordinate values of the tilting manipulation signal and the swing angle of the upper swing frame, and calculating operation values for determining whether to extend/contract the target actuators and operation ranges of the target actuators, in order to tilt the upper swing frame against a reference surface in accordance with the tilting manipulation signal.

2. The manual leveling control system of claim 1, wherein the control unit comprises:
a manipulation signal analysis module outputting an angle of the coordinates and a coordinate distance or size from an original point to a coordinate point in accordance with the coordinate values;
a compensation axis angle calculation module calculating a compensation axis angle from the coordinate angle and the swing angle of the upper swing frame, wherein the compensation axis angle indicates in plane view an angle between a reference axis of the reference surface and a tilting compensation axis on a horizontal surface of the upper swing frame, wherein the tilting compensation axis forms a tilting angle to be compensated between the reference surface and the horizontal surface of the upper swing frame; and
an operation value calculation module calculating operation values of the target actuators to be operated from the coordinate distance or size and the compensation axis angle.

3. The manual leveling control system of claim 2, wherein the actuators radially positioned around the center of the tilting unit are respectively coupled to both sides of tilt shafts which are substantially orthogonal to each other in ‘X’ shape in plane view so that the tilt shafts seesaw;
the coordinate distance or size outputted from the manipulation signal analysis module corresponds to an upward or downward tilting angle of the upper swing frame to be compensated or an ascending or descending length of one side of the tilting unit on the tilting compensation axis in accordance with the upward or downward tilting angle to be compensated; and
the operation value calculation module calculates the operation values for controlling the actuators connected to both sides of the same tilt shaft so as to be extended/contracted and vice versa with the same operation range.

4. A manual leveling control method for construction equipment having a tilting unit that is coupled between a lower frame having a traveling means and an upper swing frame having a cab and is so operated by actuators as to tilt the upper swing frame, wherein the upper swing frame swivels against the tilting unit, the manual leveling control method comprising:
(A) receiving a tilting manipulation signal corresponding to position coordinate values generated in accordance with a manipulation of a tilting manipulation input device, and calculating a coordinate angle and a coordinate distance or size from an original point to a coordinate point on a coordinate system having coordinate axes corresponding to left/right direction and front/rear direction of the upper swing frame;
(B) calculating a compensation axis angle from the coordinate angle and the swing angle of the upper swing frame, wherein the compensation axis angle indicates in plane view an angle between a reference axis of the reference surface and a tilting compensation axis on a horizontal surface of the upper swing frame, wherein the tilting compensation axis forms a tilting angle to be compensated between the reference surface and the horizontal surface of the upper swing frame; and
(C) calculating an operation value for determining whether to extend/contract an actuator and an operation range of the actuator, which is determined as target actuators to be operated among actuators radially positioned around the center of the tilting unit, from the coordinate distance or size and the compensation axis angle, in order to tilt the upper swing frame against the reference surface in accordance with the tilting manipulation signal.

5. The manual leveling control method of claim 4, wherein the step (A) comprises:
if the position coordinate values are expressed as the coordinate angle against any one coordinate axis and the coordinate distance or size from the original point to the coordinate point, outputting the coordinate angle and the coordinate distance or size from the tilting manipulation signal of the position coordinate values; and
if the coordinate values are expressed as X, Y coordinate values of a coordinate system having an X axis representing the left/right direction of the upper swing frame and a Y axis representing the front/rear direction of the upper swing frame, calculating the coordinate angle against any one coordinate axis and the coordinate distance or size from the original point to the coordinate point, from the X, Y coordinate values.

6. The manual leveling control method of claim 5, wherein the actuators radially positioned around the center of the tilting unit are A+ actuator and A− actuator coupled to both sides of one of tilt shafts which are substantially orthogonal to each other in ‘x’ shape in plane view so that the tilt shafts seesaw, and B+ actuator and B− actuator coupled to both sides of the other tilt shaft;
the coordinate distance or size outputted in the step (A) corresponds to an upward or downward tilting angle of the upper swing frame to be compensated or an ascending or descending length of one side of the tilting unit on the tilting compensation axis in accordance with the upward or downward tilting angle to be compensated; and
the step (C) calculates the operation values for controlling the actuators connected to both sides of the same tilt shaft so as to be extended/contracted and vice versa with the same operation range.

7. The manual leveling control method of claim 6, wherein an axis in the front direction of the lower frame that is the basis of the swing angle coincides with the direction of the reference axis of the reference surface;
the coordinate angle is measured on the basis of a positive Y axis that corresponds to the front direction of the upper swing frame, and an angle having the same sign as the swing angle refers to the same direction as the swing angle while an angle having an opposite sign to the swing angle refers to an opposite direction to the swing angle;
the reference axis is a vertical axis along lengthwise direction in plane view, which passes through the center of an ‘X’-shaped cross plane of the tilt shafts, and an upper side thereof refers to a positive direction, and
the compensation axis angle is calculated as the sum of the coordinate angle and the swing angle.

8. The manual leveling control method of claim 7, wherein the step (C) divides an operation region into sectors in accordance with the compensation axis angle on the basis of the tilt shafts on the ‘x’-shaped cross plane;
if it is assumed that the upper left side actuator of the tilt shaft arranged from the upper left side of the reference axis to the lower right side is denoted as A+ actuator and the upper right side actuator of the tilt shaft arranged from the upper right side of the reference axis to the lower left side is denoted as B− actuator, A− and B+ actuators are controlled to be extended or contracted in opposite manner to the A+ and B− actuators;
the positive sign of the operation value makes the actuators operate in the same direction as the tilting direction to be compensated in the coordinate direction according to the tilting manipulation signal, that is, a downward tilting signal makes the actuators contract and an upward tilting signal makes the actuators extend, while the negative sign of the operation value makes the actuators operate in the opposite direction;
the maximum ascending or descending length h of the tilting unit to be tilt-compensated on a circular arc having a radius of r is calculated from the coordinate distance or size, wherein the radius of r is formed as connecting points where the actuators joint the tilt shafts are connected;
i) if the compensation axis angle is more than −45° and less than 45°, i.e. if the size of the compensation axis angle α is in the range of −45≦α<45, the operation value A_{ν}⁺ of A+ actuator is obtained as
$${A}_{v}^{+} = \frac{45 - α}{90} \times h$$
from
$$\frac{π}{2} r \text{:} h = ( \frac{π}{4} - \frac{π}{180} \times α ) r \text{:} {A}_{v}^{+} ,$$
and the operation value B_{ν}⁻ of B− actuator is obtained as
$${B}_{v}^{-} = \frac{45 + α}{90} \times h$$
from
$$\frac{π}{2} r \text{:} h = ( \frac{π}{4} + \frac{π}{180} \times α ) r \text{:} {B}_{v}^{-} ;$$
ii) if the compensation axis angle is more than 45° and less than 135°, i.e. if the compensation axis angle α is in the range of 45≦α<135, the operation value A_{ν}⁺ of A+ actuator is obtained as
$${A}_{v}^{+} = - \frac{α - 45}{90} \times h$$
from
$$\frac{π}{2} r \text{:} h = - ( \frac{π}{180} \times α - \frac{π}{4} ) r \text{:} {A}_{v}^{+} ,$$
and the operation value B_{ν}⁻ of B− actuator is obtained as
$${B}_{v}^{-} = \frac{135 - α}{90} \times h$$
from
$$\frac{π}{2} r \text{:} h = [ π - ( \frac{π}{4} + \frac{π}{180} \times α ) ] r \text{:} {B}_{v}^{-} ;$$
iii) if the compensation axis angle is in the range of 135≦α<225 in a state that the compensation axis angle in the range of 135≦α<180 or in the range of −180≦α<−135 is the same as the compensation axis angle in the range of 135≦α<225, the operation value A_{ν}⁺ of A+ actuator is obtained as
$${A}_{v}^{+} = - \frac{225 - α}{90} \times h$$
from
$$\frac{π}{2} r \text{:} h = - ( \frac{5 π}{4} - \frac{π}{180} \times α ) r \text{:} {A}_{v}^{+} ,$$
and the operation value B_{ν}⁻ of B− actuator is obtained as
$${B}_{v}^{-} = - \frac{α - 135}{90} \times h$$
from
$$\frac{π}{2} r \text{:} h = - ( \frac{π}{180} \times α - \frac{3 π}{4} ) r \text{:} {B}_{v}^{-} ;$$
and
iv) if the compensation axis angle is more than −135° and less than −45°, i.e. if the compensation axis angle α is in the range of −135≦α<−45, the operation value A_{ν}⁺ of A+ actuator is obtained as
$${A}_{v}^{+} = \frac{135 - \vert α \vert}{90} \times h = \frac{135 + α}{90} \times h$$
from
$$\frac{π}{2} r \text{:} h = ( \frac{3 π}{4} - \frac{π}{180} \times \vert α \vert ) r \text{:} {A}_{v}^{+} ,$$
and the operation value B_{ν}⁻ of B− actuator is obtained as
$${B}_{v}^{-} = - \frac{\vert α \vert - 45}{90} \times h = \frac{α + 45}{90} \times h$$
from
$$\frac{π}{2} r \text{:} h = - ( \frac{π}{180} \times \vert α \vert - \frac{π}{4} ) r \text{:} {B}_{v}^{-} .$$

9. The manual leveling control method of claim 7, wherein the step (C) divides an operation region of the respective actuator into 8 parts in accordance with the range of the compensation axis angle on the basis of the tilt shaft on the ‘x’-shaped cross plane, the reference axis, and a horizontal axis perpendicular to the reference axis and passing through a cross center; calculates an operation angle CPer for limiting the operation range in accordance with the sector where the actuator is positioned from the compensation axis angle CAng in the range of 0˜360; calculates control values AVCon of the A+ and A− actuators and control values BVCon of the B+ and B− actuators as the operation values on the basis of the operation angle and the coordinate distance or size; and control values of the A− and B− actuators are opposite with control values of the A+ and B+ actuators;
(C1) in the range of 0<Compensation Axis Angle≦45, calculating the operation angle CPer by
$$CPer = CAng \times \frac{50}{45} + 50 ,$$
calculating the control value AVCon of A+ actuator by AVCon=[(100−CPer)×JAmp/100], and calculating the control value BVCon of B+ actuator by BVCon=−1×(CPer×JAmp/100);
(C2) in the range of 45<Compensation Axis Angle≦90, calculating the operation angle CPer by
$$CPer = ( CAng - 45 ) \times \frac{50}{45} ,$$
calculating the control value AVCon of A+ actuator by AVCon=−1×(CPer×JAmp/100), and calculating the control value BVCon of B+ actuator by BVCon=−1×[(100−CPer)×JAmp/100];
(C3) in the range of 90<Compensation Axis Angle≦135, calculating the operation angle CPer by
$$CPer = ( CAng - 90 ) \times \frac{50}{45} + 50 ,$$
calculating the control value AVCon of A+ actuator by AVCon=−1×(CPer×JAmp/100), and calculating the control value BVCon of B+ actuator by BVCon=−1×[(100−CPer)×JAmp1100];
(C4) in the range of 135<Compensation Axis Angle≦180, calculating the operation angle CPer by
$$CPer = ( CAng - 135 ) \times \frac{50}{45}$$
calculating the control value AVCon of A+ actuator by AVCon=−1×[(100−CPer)×JAmp/100], and calculating the control value BVCon of B+ actuator by BVCon=CPer×JAmp/100;
(C5) in the range of 180<Compensation Axis Angle≦225, calculating the operation angle CPer by
$$CPer = ( CAng - 180 ) \times \frac{50}{45} + 50 ,$$
calculating the control value AVCon of A+ actuator by AVCon=−1×[(100−CPer)×JAmp/100], and calculating the control value BVCon of B+ actuator by BVCon=CPer×JAmp/100;
(C6) in the range of 225<Compensation Axis Angle≦270, calculating the operation angle CPer by
$$CPer = ( CAng - 225 ) \times \frac{50}{45} ,$$
calculating the control value AVCon of A+ actuator by AVCon−CPer×JAmp/100, and calculating the control value BVCon of B+ actuator is calculated by BVCon=(100−CPer)×JAmp/100;
(C7) in the range of 270<Compensation Axis Angle≦315, calculating the operation angle CPer by
$$CPer = ( CAng - 270 ) \times \frac{50}{45} + 50 ,$$
calculating the control value AVCon of A+ actuator by AVCon=CPer×JAmp/100, and calculating the control value BVCon of B+ actuator by BVCon=(100−CPer)×JAmp/100;
(C8) in the range of 315<Compensation Axis Angle≦359, calculating the operation angle CPer by
$$CPer = ( CAng - 315 ) \times \frac{50}{45} ,$$
calculating the control value AVCon of A+ actuator by AVCon=[(100−CPer)×JAmp/100], and calculating the control value BVCon of B+ actuator by BVCon=−1×(CPer×JAmp/100); and
(C9) in the range of Compensation Axis Angle=0, calculating the operation angle CPer=50, calculating the control value A VCon of A+ actuator by AVCon=[(100−CPer)×JAmp/100], and calculating the control value BVCon of B+ actuator by BVCon=−1×(CPer×JAmp/100).
